(19) United States
(12) Patent Application Publication
(10) Pub. No.: US 2026/0328697 A1
(43) Pub. Date: Oct. 22, 2026

(54) GRAIN DETERMINATION SYSTEM

(71) Applicant: SATAKE CORPORATION, Chiyoda-ku, Tokyo (JP)

(72) Inventors: Yoshihisa NAKATA, Chiyoda-ku, Tokyo (JP); Hiroaki TAKEUCHI, Chiyoda-ku, Tokyo (JP)

(73) Assignee: SATAKE CORPORATION, Chiyoda-ku, Tokyo (JP)

(21) Appl. No.: 19/115,852

(22) PCT Filed: Oct. 17, 2023
(86) PCT No.: PCT/JP2023/037593

§ 371 Date: Mar. 27, 2025

(30) Foreign Application Priority Data
Oct. 31, 2022 (JP) 2022-174939

(51) Int. Cl. G01N 21/85; G06V 10/82

(52) U.S. Cl. CPC G01N 21/85; G06V 10/82; G01N 2021/8592

(57) ABSTRACT

An embodiment has: an image capturing unit configured to capture an image of a grain placed on a tray; a server configured to communicate with the image capturing unit and determine a grade of the grain in response to receiving a captured image of the grain from the image capturing unit; and a terminal configured to communicate with the server, perform image capturing control on the image capturing unit via the server, and display and output a determination result on the grain received from the server.

### TECHNICAL FIELD

The present invention relates to a grain determination system with use of a terminal and a server.

### BACKGROUND ART

A grain inspection system as disclosed in Patent Literature 1 is conventionally known that intends to determine grains inexpensively. This grain inspection system is formed of a mobile terminal such as a smartphone equipped with a camera, a display unit, and a communication unit and a management device connected to the mobile terminal via the Internet, and the management device is operated on cloud.

When the grade of a grain sample is determined in the above grain inspection system, an image of the grain sample is captured by the camera mounted on the mobile terminal, and a captured and acquired grain sample image is transmitted to the management device. The grain sample image transmitted to the management device is processed in the management device, and the grade of grains is determined by a determination scheme using AI. The obtained determination result is transmitted from the management device to the mobile terminal and displayed on the display unit mounted on the mobile terminal.

Therefore, a user is able to determine the grade of grains inexpensively as long as the user has a general-purpose mobile terminal such as a smartphone without being required to introduce any other devices.

### CITATION LIST

### Patent Literature

Patent Literature 1: Japanese Patent Application Laid-Open No. 2022-018322

### SUMMARY OF INVENTION

### Technical Problem

In determination of grains using a device, the user may set its own determination criterion. For example, the user may set a numerical value such as a length, a width, or a thickness of a grain as a determination criterion for each variety. Accordingly, determination methods using a simple algorithm provided with a determination threshold have an advantage of easy setting change.

In the determination method relying on AI using a learning model as with the grain inspection system of Patent Literature 1 described above, however, there is a problem that it is difficult for the user to easily change the setting as in the case described above.

In addition, cameras mounted on mobile terminals such as smartphones differ in the specification about resolution, color of images, or the like in accordance with manufacturers, types, or models of smartphones. It is thus difficult to obtain determination results with constant accuracy from images of grains captured by these different cameras.

In view of the above problems, the present invention intends to provide a grain determination system that can perform grade determination on grains more accurately and effectively than the conventional art.

### Solution to Problem

(1) To solve the above problem, an embodiment of the present invention is configured as a grain determination system including: an image capturing unit configured to capture an image of a grain placed on a tray; a server configured to communicate with the image capturing unit and determine a grade of the grain in response to receiving a captured image of the grain from the image capturing unit; and a terminal configured to communicate with the server, perform image capturing control on the image capturing unit via the server and, display and output a determination result on the grain received from the server.
(2) The server includes a determination unit configured to determine the grade of the grain, and the determination unit has a first determination method to determine the grade of the grain by using artificial intelligence with a learning model and a second determination method to determine the grade of the grain by using a simple algorithm and is configured to select at least any one determination method of the first determination method and the second determination method.
(3) The first determination method is intended for a first determination item about which determination on the grain is relatively easy, and the second determination method is intended for a second determination item about which determination on the grain is relatively difficult.
(4) The first determination item includes at least any of a body-cracked grain, a green immature grain, a broken grain, green opaque-kernel rice, a whole colored grain, and rusty kernel rice, and the second determination item includes at least any one of a milky white grain, basal immature grain, a dorsal white grain, white opaque-kernel rice, a partially colored grain, a well-ordered grain, a malformed grain, a germinated grain, a grain with rotten embryo or endosperm, and an immature grain difficult to determine other than the green immature grain and the basal immature grain.
(5) The determination unit includes a measurement value calculation unit configured to calculate a predetermined measurement value from a captured image of the grain and a determination score value calculation unit configured to calculate a determination score value by using artificial intelligence with the learning model, and when the predetermined measurement value or the determination score value is close to a determination threshold and/or when the predetermined measurement value or the determination score value deviates by a predetermined ratio or greater from a determination threshold, an image of the grain is displayed on the terminal to enable user determination.
(6) The image capturing unit has unique identification information that is unique to an individual image capturing unit, and the terminal is configured to accept entry of the unique identification information and associate the terminal with the image capturing unit to control the image capturing unit.

### Advantageous Effects of Invention

According to the embodiment of the invention of (1) described above, the grain determination system is formed of: an image capturing unit that can capture an image of a grain; a server that can determine the grade of the grain based on the captured image of the grain; and a terminal that can perform image capturing control on the image capturing unit via the server and display and output a determination result on the grain received. Thus, since the image capturing unit of the same specification can be used to capture images of a grain, images of a grain having a uniform image quality can be obtained compared to an image captured by a camera mounted on a conventional smartphone.

Further, since the operation from the image capturing control on the image capturing unit to the display output of the determination result on a grain can be performed at user's hand on the terminal, the grade determination on a grain can be performed more accurately and effectively than in the conventional art.

According to the embodiment of the invention of (2) described above, since the embodiment is configured to have the first determination method to determine the grade of the grain by using artificial intelligence with a learning model and the second determination method to determine the grade of the grain by using a simple algorithm and enable selection of at least any one of these determination methods, the grade determination on the grain can be performed accurately and effectively in accordance with a determination item for grains.

According to the embodiment of the invention of (3) described above, the first determination method or the second determination method can be selected in accordance with a difficulty level of determination for each determination item. Accordingly, the grade determination on a grain can be performed more accurately and effectively than in the conventional art in accordance with a determination item for the grain.

According to the embodiment of the invention of (4) described above, the embodiment is configured such that the first determination item used by the first determination method described above includes at least any of a body-cracked grain, a green immature grain, a broken grain, green opaque-kernel rice, a whole colored grain, and rusty kernel rice, and the second determination item used by the second determination method described above includes at least any one of a milky white grain, basal immature grain, a dorsal white grain, white opaque-kernel rice, a partially colored grain, a well-ordered grain, a malformed grain, a germinated grain, a grain with rotten embryo or endosperm, and an immature grain difficult to determine other than the green immature grain and the basal immature grain. Thus, the grade determination on a grain can be performed more accurately and effectively than in the conventional art in accordance with a difficulty level of the determination for each determination item.

According to the embodiment of the invention of (5) described above, when the predetermined measurement value calculated from a captured image of a grain or the determination score value calculated by using artificial intelligence with a learning model is close to a determination threshold and/or when the predetermined measurement value or the determination score value deviates by a predetermined ratio or greater from a determination threshold, the image of the grain is displayed on the terminal to enable user determination. Such a configuration enables the user to make determination through visual observation on such a grain that is difficult to automatically determine, and the grade determination on grains can be performed accurately and effectively.

According to the embodiment of the invention of (6) described above, the unique identification information on the image capturing unit is input to the terminal, and thereby the terminal is associated with the image capturing unit and enabled to control the image capturing unit. Therefore, the grain determination system can be connected to any image capturing unit as appropriate and controlled via a terminal individually possessed by the user (for example, a smartphone), and the grade determination on grains can be performed accurately and effectively with an inexpensive system configuration.

### BRIEF DESCRIPTION OF DRAWINGS

FIG. 1 is a schematic configuration diagram of a grain determination system of the present embodiment.

FIG. 2 is a sectional view of an image capturing unit of the present embodiment.

FIG. 3 is a schematic block diagram of a management unit of a cloud server of the present embodiment.

FIG. 4 is a flow diagram illustrating a grain determination form of the present embodiment.

FIG. 5 is a flow diagram illustrating an example of an image capturing form with the image capturing unit of the present embodiment.

FIG. 6 is an illustration diagram indicating determination items for each determination method in the embodiment.

FIG. 7 is a flow diagram illustrating a grain determination form of the present embodiment.

### DESCRIPTION OF EMBODIMENTS

One embodiment of a grain determination system of the present invention will be described below with reference to the drawings.

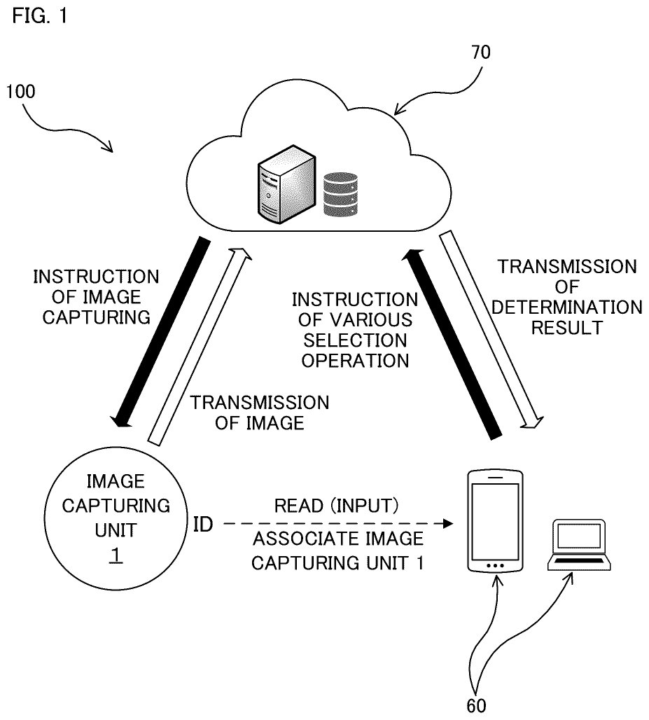

FIG. 1 illustrates a schematic configuration diagram of a grain determination system 100 of the present embodiment. As illustrated, the grain determination system 100 is formed of at least an image capturing unit 1 that can capture an image of grains 2 placed on a tray 50, a cloud server 70 that can communicate with the image capturing unit 1 and determine the grade of the grains 2 in response to receiving a captured image of the grains 2 from the image capturing unit 1, and a terminal 60 that can communicate with the cloud server 70 and perform image capturing control on the image capturing unit 1 via the cloud server 70 and display and output a determination result on the grains 2 received from the cloud server 70. Note that, as the tray 50 of the present embodiment, a grain judging plate as disclosed in Japanese Patent Application Laid-Open No. 2014-109567 is used. This grain judging plate has a transparent bottom face. Further, a grain judging plate called a carton may also be used as the tray 50.

To explain in more detail, a smartphone possessed by a user can be used as the terminal 60, and grade determination on the grain 2 can be performed by a web application downloaded to the terminal 60 in advance.

Note that the terminal 60 is not limited to a smartphone, and a PDA, a tablet terminal, a laptop PC, a desktop PC, or the like can be used. In particular, those with excellent portability can be suitably used.

Prior to determination of the grade of samples of the grain 2, the user associates the image capturing unit 1 and the terminal 60 for use with each other. That is, the image capturing unit 1 has unique identification information that is unique to an individual image capturing unit, and once the unique identification information is input to the terminal 60, the terminal 60 is associated with the image capturing unit 1. Accordingly, the image capturing unit 1 can be controlled by the terminal 60.

Note that, as a method of inputting unique identification information to the terminal 60, a two-dimensional code displayed on the image capturing unit 1 may be read by a camera mounted on the terminal 60, or an ID individually provided to the image capturing unit 1 may be keyed into the terminal 60. Further, the method may be operation to select one of a plurality of pre-registered image capturing units 1 displayed on the terminal 60.

Next, the user uses the web application of the terminal 60 to input the type, the variety, sample information, or the like on the grain 2 to be determined and provides an instruction to start image capturing by the image capturing unit 1. The instruction to start image capturing or the like are transmitted to the image capturing unit 1 via the cloud server 70. The captured image captured by the image capturing unit 1 is transmitted to the cloud server 70, and grade determination described later is performed. Then, a determination result on the grains 2 or the like are transmitted to the terminal 60. Note that an image of the grains 2 may be captured in advance, and the type, the variety, or sample information on the grains 2 may be then input for the captured image of the grain 2. Further, although the cloud server 70 is used in the present embodiment, the embodiment is not necessarily limited to the use of such a cloud computing technology, and, for example, typical servers located within business premises or within related companies that use the terminal 60 can also be used.

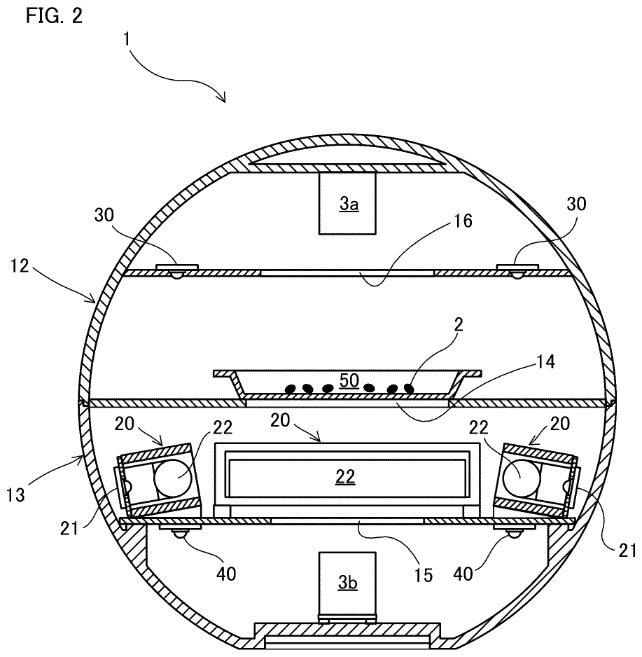

FIG. 2 illustrates a sectional view of the image capturing unit 1 of the present embodiment. The image capturing unit 1 can irradiate the grain 2 with light to capture images from above and below the grain 2. The image capturing unit 1 can be used for determining the quality of grains such as rice, wheats, beans, corns, or the like. Note that the grain determination system 100 of the present embodiment is intended to determine granular objects such as rice, wheats, beans, corns, or the like.

As illustrated, the image capturing unit 1 is mainly formed of an upper casing 12 and a lower casing 13. The grains 2 to be determined are put in a dish-like transparent tray 50, and this tray 50 is placed on an opened circular placement part 14. Further, an upper camera 3a that can capture an image of the grains 2 from above is attached inside the upper casing 12. A lower camera 3b that can capture an image of the grains 2 from below is attached inside the lower casing 13. Furthermore, a bottom opening 15 is formed above the lower camera 3b.

Further, upper light sources 30 are provided diagonally above the tray 50 and provided with a plurality of white LEDs as a light emitting part. First lower light sources 40 and second lower light sources 20 are provided diagonally below the tray 50. In each of the first lower light sources 40, a plurality of white LEDs as a light emitting part are provided directed downward.

In each of the second lower light sources 20 described above, a plurality of white LEDs 21 as a light emitting part are provided directed to a cylindrical lens 22. To explain in more detail, the white LEDs 21 and the cylindrical lens 22 are provided in a reflector having a U-shaped cross section. Further, direct light from the white LEDs 21 is emitted to the bottom face of the tray 50 through the cylindrical lens 22 at an angle illustrated in FIG. 2. Such a configuration enables emission of light to the grain 2 placed on the bottom face of the tray 50 from diagonally below and, in particular, body crack of a rice grain can be effectively detected.

Note that the upper light source 30, the first lower light source 40, and the second lower light source 20 are not necessarily limited to white LEDs, and a combination of single-color LEDs of red (R), green (G), and blue (B) can be used.

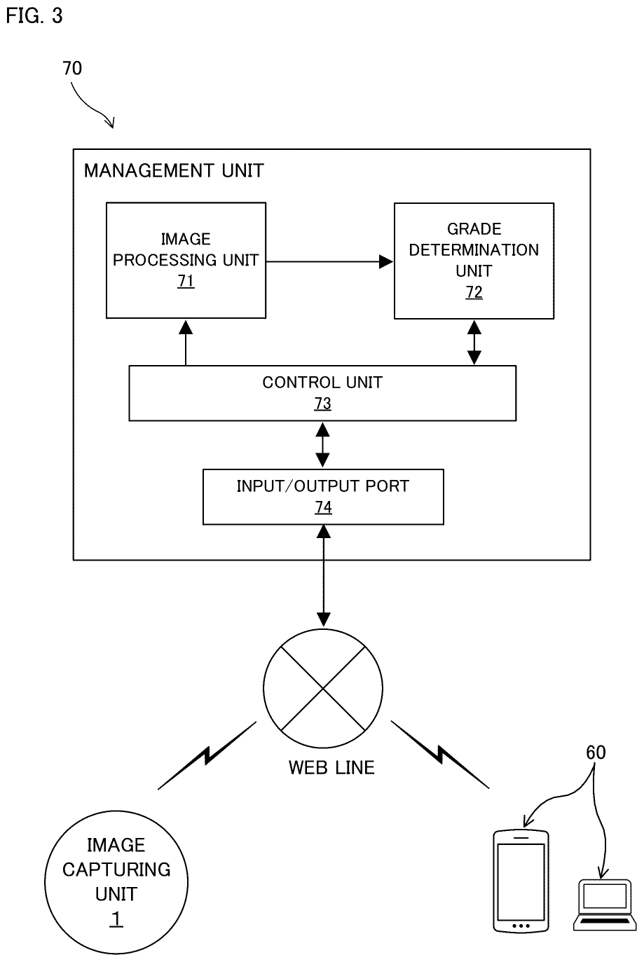

Next, FIG. 3 illustrates a schematic block diagram of a management unit in the cloud server 70 of the present embodiment. The management unit is provided with at least an image processing unit 71 that can perform image processing on a captured image received from the image capturing unit 1, a grade determination unit 72 that can calculate various measurement values from the processed image of the grain 2 image-processed by the image processing unit 71 and determine the grade of this grain 2, a control unit 73 that can control various devices forming the grain determination system 100, and an input/output port 74 which is connected to a communication line and through which various signals are input from/output to the image capturing unit 1 and the terminal 60. Note that a storage unit (not illustrated) that stores necessary data may be provided.

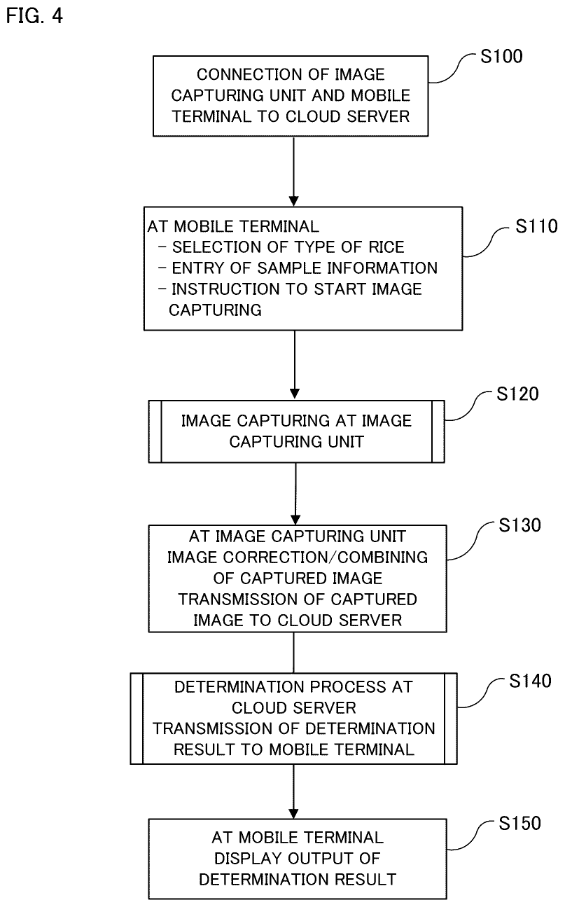

Next, a process flow performed by the grain determination system 100 will be described based on the flow diagram of FIG. 4. First, the image capturing unit 1 is connected to the cloud server 70 via predetermined setting operation after started up by the user. In addition, the image capturing unit 1 is connected to the cloud server 70 by using the web application of the terminal 60 via predetermined setting operation after started up by the user. The image capturing unit 1 and the terminal 60 for use are then associated with each other from the web application. This associating process is performed by entry of unique identification information on the image capturing unit 1 to the terminal 60 as described above (step S100).

Next, the type, the variety, sample information, or the like on the grain 2 to be determined are input by using the web application of the terminal 60, and an instruction to start image capturing by the image capturing unit 1 or the like are provided (step S110). The image capturing unit 1 instructed to start image capturing then performs image capturing of the grains 2 placed on the tray 50 by the user (step S120).

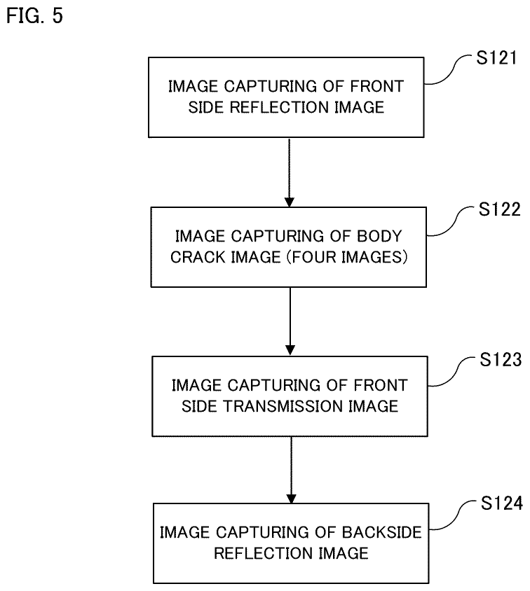

As illustrated in the flow diagram of FIG. 5, in the present embodiment, the upper light sources 30 of the image capturing unit 1 are first turned on, and a front side reflection image is captured by the upper camera 3a (step S121). The captured image is used for determination on immature grains, broken grains, colored grains, or the like.

Next, four second lower light sources 20 of the image capturing unit 1 are turned on sequentially every 90 degrees, and four body crack images are captured by the upper camera 3a (step S122). The captured images are used for determination on body-cracked grains.

Next, all the four second lower light sources 20 of the image capturing unit 1 are turned on at the same time, and a front side transmission image is captured by the upper camera 3a (step S123). The captured image is used for determination on immature grains and opaque-kernel rice together with the front side reflection image described above (step S121).

Next, all the four second lower light sources 20 of the image capturing unit 1 are turned on at the same time, and a backside reflection image is captured by the lower camera 3b (step S124). The captured image is used for determination on colored grains present on the backside of the grains 2.

Next, as illustrated in FIG. 4, color correction or distortion correction is performed on each captured image in the image capturing unit 1, and at this time, four body crack images are combined. These captured images are transmitted to the cloud server 70 as data such as an image file or an Ini file (step S130). Note that the color correction, the distortion correction, and combining of body crack images described above may be performed on the cloud server 70 side.

Each captured image transmitted from the image capturing unit 1 is subjected to a determination process at the cloud server 70. In the present embodiment, based on the four captured images, namely, the front side reflection image (step S121), the body crack image (step S122), the front side transmission image (step S123), and the backside reflection image (step S124), operations of (1) identifying of the grain 2 (recognition of an image of each grain) and classification, (2) matching of each grain 2, (3) grain determination with a class of higher priority based on a determination result on each grain 2, (4) calculation of the length, the width, the area, the whiteness, or the like of each grain 2 based on segmentation data, or the like are performed. Note that the operation of (2) described above is to adapt an image of each grain 2 of any one of the above four captured images with images of the grain 2 of the remaining three captured images. Specifically, the operation of (2) described above is to have an image of a grain A recognized in the four captured images, respectively. Further, in the present embodiment, a single grain 2 is classified for each of the above four captured images. Thus, a single grain 2 may be classified into different classes in respective captured images. To address such a case, the priority is provided for each class, and a determination result for a class of higher priority is prioritized in the operation of (3) described above.

Further, in the cloud server 70, it is possible to aggregate, for all the grains, the weight ratio or the grain quantity ratio for each class or the number of grains for each category based on each calculation data. Furthermore, a histogram calculation for the length, the width, the area, the whiteness, or the like or calculation of a mean value and a standard deviation are also possible. Further, the embodiment is configured such that these values are stored in a database constructed in a storage unit (not illustrated).

Further, the determination results including respective calculation data or the like described above are transmitted to the terminal 60 (step S140), and in response to user operation, the determination result is output and displayed via the web application of the terminal 60 (step S150).

Next, an automatic determination method in the present embodiment will be described.

As a method for determining the grade of the grains 2, the grade determination unit 72 of the cloud server 70 of the present embodiment can automatically determine the grain 2 by using both a first determination method of using artificial intelligence with a learning model to determine the grade of the grain 2 and a second determination method of using a simple algorithm to determine the grade of the grain 2.

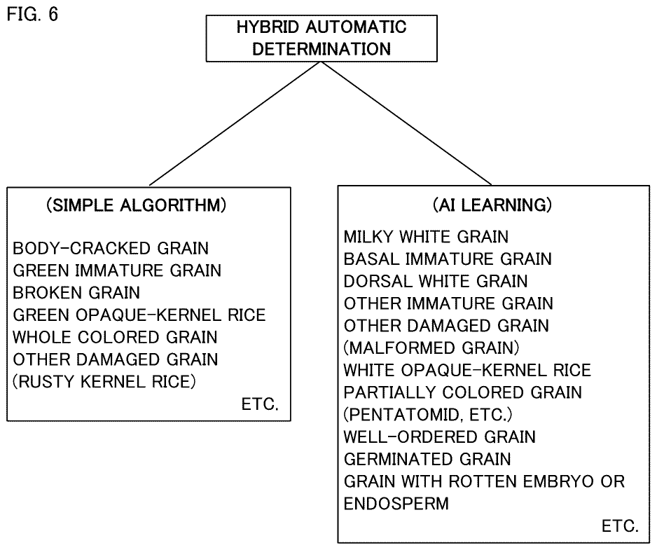

That is, as illustrated in FIG. 6, hybrid automatic determination of the automatic determination performed by a simple algorithm and the automatic determination performed by AI is made possible. Further, either one determination method of these two methods can be selected in accordance with a determination item for automatic determination.

To explain in more detail, the first determination method described above is intended to a first determination item about which determination of the grains 2 is relatively easy and can determine at least any of a body-cracked grain, a green immature grain, a broken grain, green opaque-kernel rice, a whole colored grain, and rusty kernel rice, for example. That is, the first determination method is to make determination by a simple algorithm using the length, the width, the thickness, color information, or the like of the grain 2.

On the other hand, the second determination method described above is intended to a second determination item about which determination of the grain 2 is relatively difficult and can determine at least any of, for example, a milky white grain, basal immature grain, a dorsal white grain, white opaque-kernel rice, a partially colored grain, a well-ordered grain, a malformed grain, a germinated grain, a grain with rotten embryo or endosperm, and an immature grain difficult to determine other than the green immature grain and the basal immature grain. With such a configuration, the grade determination on the grain 2 can be performed more accurately and effectively than in the conventional art in accordance with a difficulty level of determination for each determination item. Note that each determination item in the first determination method and the second determination method described above is a mere example of itemization, and it is possible to set in any manner as to which of the first determination method and the second determination method is used for determination for respective determination items.

Further, the grade determination unit 72 of the cloud server 70 includes a measurement value calculation unit that calculates a predetermined measurement value from a captured image of the grain 2 and a determination score value calculation unit that calculates a determination score value by using artificial intelligence with a learning model.

Further, the grade is determined in accordance with whether or not the predetermined measurement value calculated by the measurement value calculation unit described above is included between a set lower limit and a set upper limit for the measurement value that are determination thresholds set in advance. Further, the grade is determined in accordance with whether or not the determination score value calculated by the determination score value calculation unit described above is included between a set lower limit and a set upper limit for the determination score value that are determination thresholds set in advance.

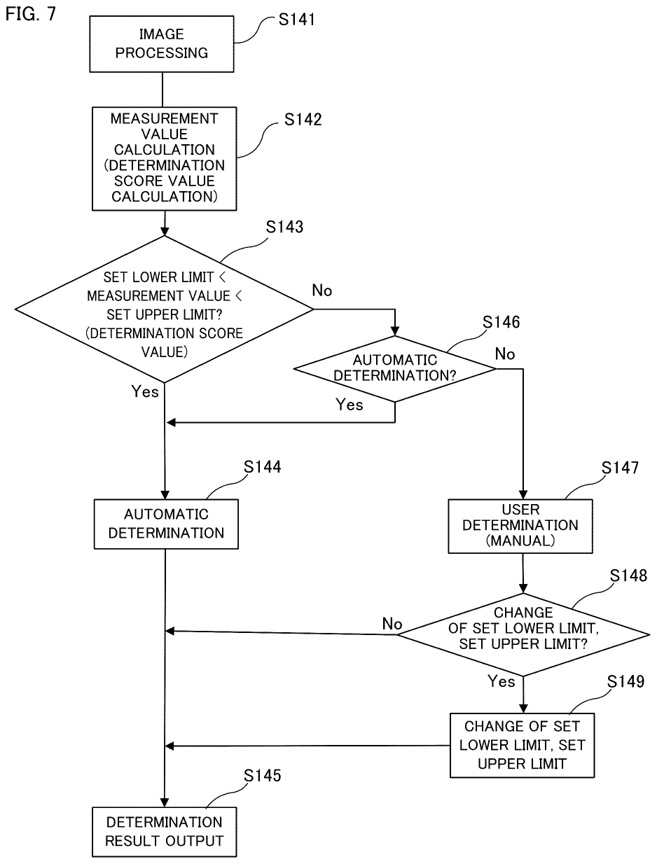

Next, FIG. 7 illustrates an example of the determination process in the cloud server 70 in a flow diagram. As illustrated, the four captured images of the front side reflection image transmitted from the image capturing unit 1 (step S121), the body crack image (step S122), the front side transmission image (step S123), and the backside reflection image (step S124) transmitted from the image capturing unit 1 are subjected to image processing required for the determination process in the image processing unit 71 of the management unit (step S141).

Next, various measurement values or determination score values are calculated in accordance with the determination item described above based on various processed images (step S142). It is then determined whether or not the calculated various measurement values or determination score values are within a range between determination thresholds set in advance as a suitable range (for example, set lower limit<measurement value (determination score value)<set upper limit) (step S143).

If the measurement value or the determination score value is within a range between the set determination thresholds, the automatic determination on the grain 2 is performed by the grade determination unit 72 of the management unit (step S144). Various determination results on the grains 2 are then output (step S145).

In contrast, if, in step S143, the measurement value or the determination score value is out of the range between the set determination thresholds described above, the user is able to select whether or not to apply automatic determination in accordance with the degree of deviation from the determination thresholds for the measurement value or the determination score value (step S146). When not selecting the automatic determination, the user makes (manual) determination through visual observation or the like of the grain 2 (step S 147). Then, as a result of the (manual) determination, the user considers whether or not it is necessary to change the set lower limit and the set upper limit of the determination thresholds (step S148) and, if necessary, the user is able to cause the grade determination unit 72 via the terminal 60 to change the set lower limit and the set upper limit of the determination thresholds for the automatic determination (step S149).

To explain in more detail, when the predetermined measurement value described above or the determination score value described above provided by artificial intelligence is close to the set upper limit or the set lower limit of the determination thresholds in step S146 described above and/or when the predetermined measurement value or the determination score value deviates by a predetermined ratio or greater from the set upper limit or the set lower limit of the determination thresholds, the image of the grain 2 is displayed on the terminal 60 to enable the user to make (manual) determination visually or the like. Such a configuration enables the user to make determination through visual observation on such a grain 2 that is difficult to automatically determine, and the grade determination on grains can be performed accurately and effectively.

Although several embodiments of the present invention have been described above, the embodiments of the invention described above are intended to facilitate understanding of the present invention and not intended to limit the present invention. The present invention may be changed or improved without departing from the spirit thereof, and the equivalents thereof are included in the present invention. Further, some of components recited in the claims and described in the specification can be combined or omitted as long as at least a part of the problem described above can be solved or at least a part of the advantageous effect is achieved.

### LIST OF REFERENCE SYMBOLS

1 image capturing unit
2 grain
3a upper camera
3b lower camera
11 tray arrangement casing
12 upper casing
13 lower casing
14 circular placement part
15 bottom opening
16 top opening
17 circumferential opening
20 second lower light source
21 white LED
22 cylindrical lens
30 upper light source
40 first lower light source
50 tray
60 terminal
70 cloud server
71 image processing unit
72 grade determination unit
73 control unit
74 input/output port
100 grain determination system

1: A grain determination system comprising:
an image capturing unit configured to capture an image of a grain placed on a tray;
a server configured to communicate with the image capturing unit and determine a grade of the grain in response to receiving a captured image of the grain from the image capturing unit; and
a terminal configured to communicate with the server, perform image capturing control on the image capturing unit via the server, and display and output a determination result on the grain received from the server.

2: The grain determination system according to claim 1,
wherein the server comprises a determination unit configured to determine the grade of the grain, and
wherein the determination unit has a first determination method to determine the grade of the grain by using artificial intelligence with a learning model and a second determination method to determine the grade of the grain by using a simple algorithm and is configured to select at least any one determination method of the first determination method and the second determination method.

3: The grain determination system according to claim 2,
wherein the first determination method is intended for a first determination item about which determination on the grain is relatively easy, and
wherein the second determination method is intended for a second determination item about which determination on the grain is relatively difficult.

4: The grain determination system according to claim 1,
wherein the determination unit comprises
a measurement value calculation unit configured to calculate a predetermined measurement value from a captured image of the grain, and
a determination score value calculation unit configured to calculate a determination score value by using artificial intelligence with the learning model, and
wherein when the predetermined measurement value or the determination score value is close to a determination threshold and/or when the predetermined measurement value or the determination score value deviates by a predetermined ratio or greater from a determination threshold, an image of the grain is displayed on the terminal to enable user determination.

5: The grain determination system according to claim 1,
wherein the image capturing unit has unique identification information that is unique to an individual image capturing unit, and
wherein the terminal is configured to accept entry of the unique identification information and associate the terminal with the image capturing unit to control the image capturing unit.

6: The grain determination system according to claim 4,
wherein the image capturing unit has unique identification information that is unique to an individual image capturing unit, and
wherein the terminal is configured to accept entry of the unique identification information and associate the terminal with the image capturing unit to control the image capturing unit.
